(19) United States
(12) Patent Application Publication
(10) Pub. No.: US 2014/0258177 A1
(43) Pub. Date: Sep. 11, 2014

(54) SYSTEM AND METHOD FOR DETECTION AND DISPLAY OF DIVERGENCE WITHIN A FINANICAL DATA SET

(71) Applicant: CHARTIQ, LLC, Crozet, VA (US)

(72) Inventor: Terrence Thorsen, Crozet, VA (US)

(73) Assignee: CHARTIQ, LLC, Crozet, VA (US)

(21) Appl. No.: 13/792,829

(22) Filed: Mar. 11, 2013

(51) Int. Cl. G06Q 40/06

(52) U.S. Cl. CPC G06Q 40/06
USPC 705/36 R

(57) ABSTRACT

A system and method provides for the detection of divergence within a financial data set including receiving a plurality of financial data points from a financial data set providing values of the financial data points over a first time interval. The method and system electronically generates a graphical display of the financial data points over the first time interval and receives a user selection of a plurality of technical indicators applicable to the financial data points, as well as electronically applying the technical indicators to the financial data points to generate technical indicator data points and electronically detecting at least one divergence between the values of the financial data set and the financial data indictor points during a second time interval. Wherein, the method and system updates the graphical display to include a graphical display of the least one divergence concurrent with the financial data points and technical indicators.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED APPLICATIONS

The present application relates to and incorporates herein: copending U.S. patent application Ser. No. ______ entitled “SYSTEM AND METHOD FOR DYNAMIC VISUAL REPRESENTATION OF ESTIMATED FINANCIAL DATA” filed Mar. ______, 2013; copending U.S. patent application Ser. No. ______ entitled “SYSTEM AND METHOD FOR FINANCIAL GAP DETECTION” filed Mar. ______ 2013; and copending U.S. patent application Ser. No. ______ entitled “SYSTEM AND METHOD FOR SEQUENTIAL COUNT VISUAL INDICATOR” filed Mar. ______, 2013.

### FIELD OF INVENTION

The disclosed technology relates generally to analysis of financial data and more specifically to the determination of one or more divergences in financial data and the generation of graphical displays thereof.

### BACKGROUND

Individuals have long utilized varying techniques to estimate price movements on tradable instruments, e.g. securities. One such technique for a price movement determination is a divergence, where a divergence is when an instrument price tracks in an opposite direction from a reference point, such as another instrument price, an index or a technical indicator, by way of example. Original divergence techniques evolved from manual plotting of price information and the reference information.

As technology has advanced, techniques have improved, including the automated generation of pricing charts for equities. For example, stock graphs are now electronically available for almost all types of equities and the user can select a time period. Based on the time period and the price information, systems can electronically generate these charts, usable for technical analysis.

In the example of using technical indicators, also known as studies, current computing techniques allow a user to select particular technical indicator. The computer then displays the prior financial history and technique indicator information. A sophisticated user may then attempt to visually identify divergences, or even manually draw anticipated divergences on the chart.

Visual recognition and manual overlay of anticipated divergences are prone to a number of problems. The precision of the rules to a proper divergence can make manual detection problematic, such that it is easy for an analyst to improperly think a divergence exists where one does not. For example, a requirement for a divergence is that there may not be interruptions in the price slope, but interruptions in the indicator slope are not permitted. Additionally, a divergence may exist over any available time frame, thus it is not uncommon for multiple divergences to overlap, another factor leading to analyst error in spotting or drawing a divergence.

Current stock analysis software includes functionality for computation of a technical indicator on this historical financial data. The system may then generate a graphical overlay of a divergence from the financial information and the technical indicator. These existing systems are extremely limited in functionality, providing a general overlay display. For example, these existing systems are specific to the particular technical indicator. Therefore, the current systems are limited to the display of only a single divergence detection between the financial information and the system-specific technical indicator.

Another shortcoming of the existing systems is the failure to detect overlapping divergences, where such overlapping divergences are useful for determining larger and broader trends. Thus, the existing systems are only able to determine divergences that do not overlap.

Current systems also fail to calculate, detect and make visible a price target for the tradable instrument, where the price target is based on the divergence. Current systems merely indicate that a price target is occurring without actually providing the actual target based on the divergence.

Additionally, current systems are limited to showing diversions, but not reversals, where a reversal is the opposite of a divergence. A positive reversal is where an uptrend price correction results in a higher low compared to the last price correction, while the indicator results in a lower low compared to the prior correction. A negative reversal happens when a downtrend rally results in a lower high compared to the last downtrend rally, but the indicator makes a higher high compared to the prior rally. Such reversals are not indicted in the current systems.

Therefore, there exists a need for a method and system for the detection of divergence within financial data and generating such divergence display, overcoming the shortcomings of the prior systems noted above.

### BRIEF DESCRIPTION

A system and method provides for the detection of divergence within a financial data set and the graphical display thereof including receiving a plurality of financial data points from a financial data set providing values of the financial data points over a first time interval. The method and system further includes electronically generating a graphical display of the financial data points over the first time interval and receiving a user selection of a plurality of technical indicators applicable to the financial data points. The method and system includes electronically applying the technical indicators to the financial data points to generate technical indicator data points and electronically detecting at least one divergence between the values of the financial data set and the financial data indictor points during a second time interval. Wherein, the method and system includes updating the graphical display to include a graphical display of the least one divergence concurrent with the financial data points and technical indicators.

The method and system includes additional embodiments for the detection of divergence within a financial data set and the graphical display thereof. In one embodiment, for each of the divergences, the method and system includes generating an implied price target and updating the graphical display to include the implied price target.

In another embodiment, the method and system includes electronically detecting at least one reversal between the values of the financial data set and the financial data indicator points and updating the graphical display to include the at least one reversal.

In another embodiment, the method and system includes the detection of a plurality of divergences, such that the method and system includes detecting, from the plurality of divergences, at least one overlapping divergence; and updating the graphical display to indicate the at least one overlapping divergence.

In another embodiment, the graphical display is also adjustable for a user-defined time period. The method and system includes receiving a time period adjustment request from the user via a user input device and updating the time period based on the time period adjustment. This time period adjustment may be the increasing or decreasing of the time period, such that the method and system includes electronically detecting any additional divergence between the values of the financial data set and the financial data indictor points during a second time interval. Thereupon, the method and system updates the graphical display to adjust the display of financial data points, technical indicators and the divergence based on the adjustment request

### BRIEF DESCRIPTION OF THE DRAWINGS

FIG. 1 illustrates a block diagram of one embodiment of a computing system providing the detection of divergence within a financial data set and a graphical display thereof;

FIG. 2 illustrates a block diagram of further processing engines for the system providing the detection of divergence within a financial data set;

FIG. 3 illustrates supplemental divergence data engines of FIG. 2 and further embodiments of the divergence detection system;

FIG. 4 illustrates a flowchart of the steps of one method of a computerized system for the detection of divergence within a financial data set and a graphical representation thereof;

FIG. 5 illustrates another embodiment of a flowchart of the steps of a method for the detection of divergence within a financial data set and graphical representation thereof;

FIG. 6 illustrates a sample screenshot of the method of FIG. 5;

FIG. 7 illustrates another embodiment of a flowchart of the steps of a method for the detection of divergence within a financial data set and graphical representation thereof;

FIG. 8 illustrates a sample screenshot of the method of FIG. 7;

FIG. 9 illustrates another embodiment of a flowchart of the steps of a method for the detection of divergence within a financial data set and graphical representation thereof;

FIG. 10 illustrates a sample screenshot of the method of FIG. 9; and

FIG. 11 illustrates sample screenshot of further embodiments of the graphical display of the divergence detected within a financial data set.

A better understanding of the disclosed technology will be obtained from the following detailed description of the preferred embodiments taken in conjunction with the drawings and the attached claims.

### DETAILED DESCRIPTION

Embodiments of the disclosed technology comprise systems and methods for visual analysis of graphical representations of financial data, including detecting and plotting of divergences from technical indicators.

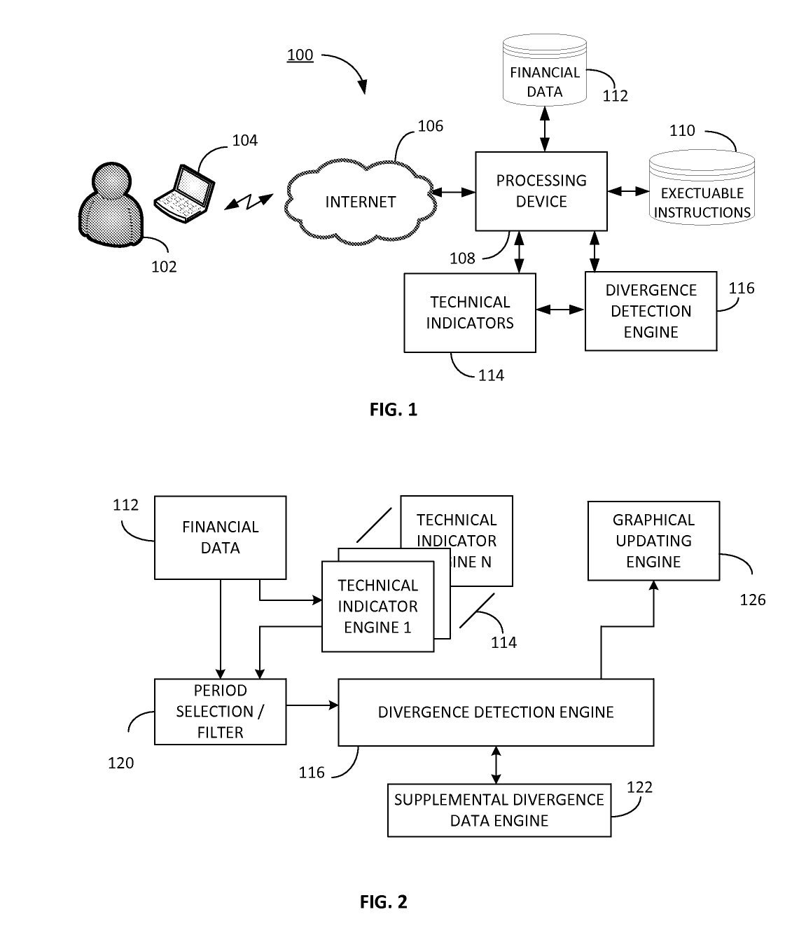

FIG. 1 illustrates one exemplary embodiment of a computing system 100 as described herein. The system 100 includes a user 102, a user computing device 104, a network 106, a processing device 108, executable instructions 110 stored in a memory device, a financial data database 112, a technical indicator calculation engine 114 and a divergence detection engine 116. It is further recognized by one skilled in the art that additional aspects of the system 100 have been omitted for brevity purposes only.

In the system 100, the user 102 may be any user or group of users. For example, the user may be a financial analyst performing computation analysis on a company's stock. In another example, the user may be a trader or broker buying and selling stocks or other equities for clients or for managing one or funds. In yet another example, the user may be an individual performing analysis prior to considering or executing trades themselves. The user may be an expert or professional, as well as be a novice to the management and trading systems.

The user device 104 may be any suitable computing device working in either a stand alone or networked environment. For example, the user device 104 may be a laptop or desktop computer running a browser or other type of application for communicating across the network. In another example, the device 104 may be a smart phone, tablet or other mobile computing device running a browser or application for communication and user input/output. In yet another example, the device 104 can be a dedicated terminal for stock and equity management activities. In one embodiment, the device 104 interfaces across the network 106, whereby processing operations are performed on the network side, in a software-as-a-service manner. In another embodiment, processing operations described below on the network side may also be disposed within the user device 104 or distributed between the network and the device 104.

The network 106 is most generally referred to as the Internet. This network 106 may be any suitable type of network, including but not limited to a local area network, wide area network, virtual private network, among others. In general terms, the network 106 provides for data communication thereacross, including any suitable protocol transmissions and security measures as recognized by one skilled in the art. The network 106 provides the medium for data communication between the device 104 and the processing device 108.

The processing device 108 may be one or more processing devices operative to perform processing operations in response to executable instructions 110. The processing device 108 may be disposed in one or more servers or other network locations, not expressly designated in FIG. 1. The processing operations may be performed in a unitary processing system or in another embodiment may be distributed across one or more processing systems. Whereby, the processing device is operative to perform processing operations described herein such that the user 102 receives a graphical display of the visual analysis of financial data including analysis of estimated future data.

The executable instructions 110 may be software code or other types of instructions readable by the processing device 108, stored in one or more computer readable medium, such as non-transitory medium, including for example one or more data storage devices. The data storage devices may be centrally located or can be accessible in a distributed environment, as recognized by one skilled in the art.

The financial data 112 includes historical data relating to an equity. As used herein, an equity can be any type of stock, equity, fund, fund of funds, or other tradable or exchangeable element having a value affixed thereto. The financial data 112 may be assembled within the system 100 or in another embodiment the data 112 is provided via one or more source providers. For example, the system 100 may include financial data information feeds from market sources providing timely financial data. Thus, the database 112 of FIG. 1 can be illustrative of the data, but it is recognized that in one embodiment, the financial data is provided via one or more data feeds. Moreover, the user 102 may select the equity for which the financial data is retrieved, as well as in various embodiments the time period for the underlying data.

The technical indicator calculation engine 114 may be one or more processing devices performing technical indicator calculations. In one embodiment, the engine 114 may be embedded within the processing device 108, but is illustrated separate therefrom in the system 100 for illustration purposes.

Moreover, the engine 114 may be disposed in a processing system separate from the processing device 108, such as via a networked connection. For example, a third party provider may provide a technical indicator operation, such that the processing device 108 networks out to the engine 114 for the performance of one or more technical indicator operations. In another example, technical indicator operations may be readily encapsulated within the analysis and graphical viewing system, whereby the technical indicator operations are locally performed relative to the processing device 108 for real time processing.

As described further herein, there are numerous possible technical indicator operations. Various technical indicators may be utilized. Below represents a sample listing of technical indicators and is not an exclusive or exhaustive list of routines available or usable with the system 100 of FIG. 1. Processing routines of these indicators are generally known to those skilled in the art and hence the algorithmic operations of each technical indicators are omitted for brevity purposes only. Technical indicator operations and processing routines may include: Welles Wilder Smoothing; Williams % R; Williams Accumulation Distribution; Volume Oscillator; Vertical Horizontal Filter; Ultimate Oscillator; True Range; Average True Range; Rainbow Oscillator; Price Oscillator; Momentum Oscillator; Ease of Movement; Directional Movement System; Detrended Price Oscillator; Chande Momentum Oscillator; Chaikin Volatility; Aroon Oscillator; Linear Regression R2; Linear Regression Forecast; Linear Regression Slope; Linear Regression Intercept; Performance Index; Commodity Channel Index; Chaikin Money Flow; Weighted Close; Volume Rate of Change; Typical Price; Standard Deviation; Price Rate of Change; Median Price; High Minus Low; Swing Index; Accumulative Swing Index; Comparative Relative Strength; Mass Index; Money Flow Index; Negative Volume Index; On Balance Volume; Positive Volume Index; Relative Strength Index; Trade Volume Index; Stochastic Oscillator; Stochastic Momentum Index; Fractal Chaos Oscillator; Prime Number Oscillator; Historical Volatility; Highest High Value; Lowest Low Value; Time Series Forecast; TRIX; Elder Ray; Elder Force Index; Elder Thermometer; Ehler Fisher Transform; Market Facilitation Index; Schaff Trend Cycle; QStick; Center Of Gravity; Coppock Curve; Chande Forecast Oscillator; Gopalakrishnan Range Index; Intraday Momentum Index; Klinger Volume Oscillator; Pretty Good Oscillator; RAVI; Random Walk Index; and Twiggs Money Flow.

The system 100 further includes a divergence detection engine 116, which similar to the engine 114, may be one or more stand alone processors or may be embedded into the processing device 108. The divergence detection engine 116 is operative to perform processing operations, as described in further detail below, to detect one or more divergences between the financial data and technical indicators associated with the financial data.

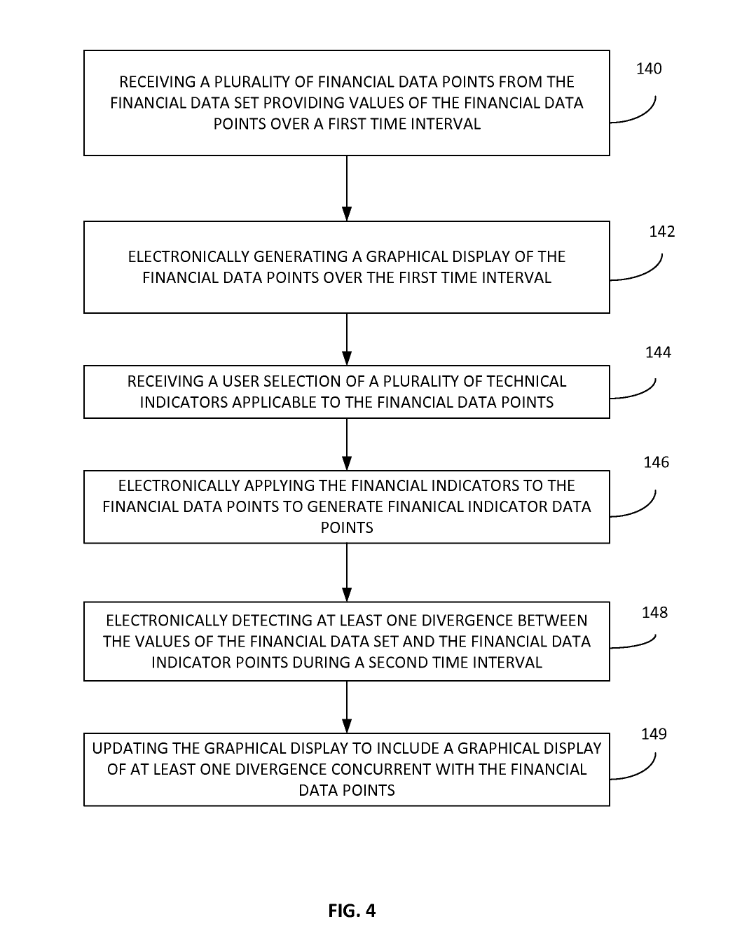

For the sake of brevity, operations of the system 100 are described in further detail below, including with respect to the flowchart of FIG. 4.

FIG. 2 illustrates a block diagram of a further embodiment of the divergence detection system. The system includes the financial data and a plurality of technical indicator engines 114, where N is any suitable integer. As illustrated herein, the technical indicator engine 114 operates for each specific study, thus providing individualized generation of technical indicator data of the financial data 112.

The system also includes a period selection/filter 120. As used herein, the period refers to the time period for selection and display of financial data, typically displayed across the x-axis in a graphical display. The period may be any suitable period of time, for example but not limited to, seconds, minutes, hours, days, weeks, months, quarters, years, etc. Wherein, the period itself is adjustable, therefore the corresponding display of financial data and technical indicators are adjusted to correspond to the time period.

The system of FIG. 2 further includes the divergence detection engine 116. This engine therein generates the divergences, and other computations, based on the comparison of the financial data values with the technical indicator values.

In the system of FIG. 2, another component is the graphical updating engine 126. This engine 126 provides for the computational transformation of the divergence data, as well as the financial data and the technical indicator data into a format for graphical display. The engine 126 uses any suitable graphing or plotting technique to overlay the display of the various financial data, technical indicator and divergence data relative to the time period information, such that the generated display is presented to the user for visual inspection.

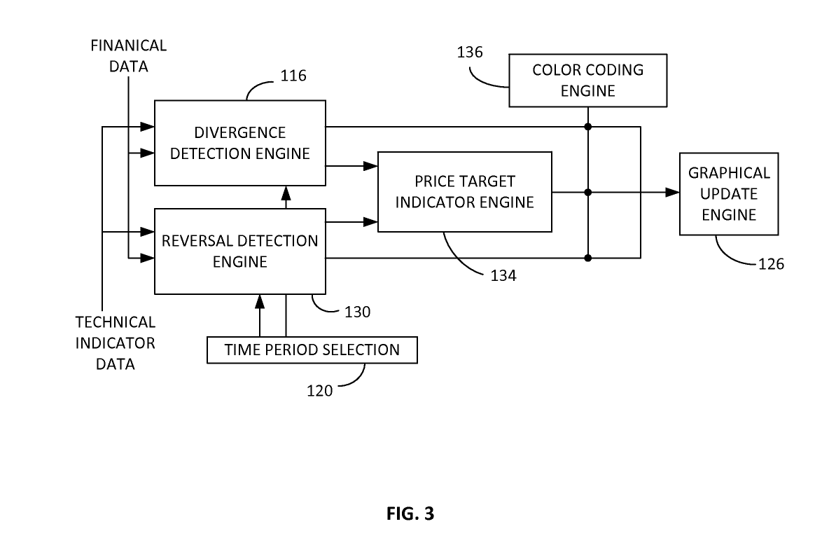

FIG. 3 provides a further illustration of an embodiment of the elements of FIG. 2. Using the computational resources in FIGS. 2 and 3, the method and system provides for the divergence detection described herein.

In FIG. 3, the processing components include the divergence detection engine 114, a reversal detection engine 130, the time period selector 120, a price target indicator engine 134, a color encoding engine 136 and the graphical update engine 126.

The divergence detection engine 116 includes the performing of a divergence detection algorithm, which in one embodiment consists of an outer loop and an inner loop. Each loop iterates through the closing prices and the value of the selected study. A positive divergence is detected when the second price iterator is less than the first price iterator, while the second study iterator is greater than the first study iterator. A negative divergence is detected when the second price iterator is greater than the first price iterator, while the second study iterator is less than the first study iterator. Any detected divergence is eliminated from the set if the theoretical line that could be drawn between the two indicator iterators is intersected by the indicator itself at any point along that time period.

The present divergence detection algorithm includes various improvements. Prior divergence algorithms search for points along a study that are lower or higher than the immediate points to the left or right. Such algorithms require input of a “degree”. A degree of 1 would select all points where only the immediate left and right points are higher or lower than the point itself. A degree of 2 would require that the nearest two points on the left and right are both higher or lower than the selected point. Such systems are incapable of all of the divergences that occur on a given time series and can rarely identify overlapping divergences, as detected by the present detection algorithm.

The reversal detection engine 130 also operates as an overlapping divergence detection engine, which operative to detect when divergences of the financial data and the technical indicator data overlap. As noted above that prior systems fail to detect such overlap, the engine 130 detects such overlap for the generation of specific illustration on a subsequent graphical display. Overlapping divergences are useful in identifying trend continuations, which are more readily visible on a subsequent display having data using the overlapping divergence detection engine 130.

A second engine is the price target indicator engine 134. As noted, prior systems merely illustrate that a price target is occurring, the engine 132 generates the price target for visual display.

For a positive divergence, the price projection is the price at the first iterator less the price at the second iterator added to the highest price on the chart between those iterators. For a negative divergence, the price projection is the price at the second iterator less the price at the first iterator subtracted from the lowest price on the chart between those iterators. For a positive reversal, the price projection is the price at the second iterator less the price at the first iterator added to the highest price on the chart between those iterators. For a negative reversal, the price projection is the price at the first iterator less the price at the second iterator subtracted from the lowest price on the chart between those iterators.

The reversal detection engine 130 detects one or more reversals, where a reversal is the opposite of a divergence. The reversal detection algorithm consists of an outer loop and an inner loop. Each loop iterates through the closing prices and the value of the selected study. A positive reversal is detected when the second price iterator is greater than the first price iterator, while the second study iterator is less than the first study iterator. A negative reversal is detected when the second price iterator is less than the first price iterator, while the second study iterator is greater than the first study iterator. Any detected reversal is eliminated from the set if the theoretical line that could be drawn between the two indicator iterators is intersected by the indicator itself at any point along that time period.

The system of FIG. 3 further includes a color coding engine 136. The graphical display may include numerous displays of divergences and possibly reversal data. This display may include overlapping divergences. Therefore, one embodiment includes the color coding for the graphical display of the data generated by the various engines 114, 130 and/or 134. Various embodiments may provide for different color variations, whereas alternative embodiments may include different line embellishments beyond color, such as dashed lines, weight/thickness of a line, by way of example.

The divergence detection engine 114 and the reversal detection engine 130 both operate on financial data and technical indicator data and may be based on the time period selection 120. As descried above, a user selects a particular time period for the analysis of the financial data.

The price target indicator engine 134 operates using output from the divergence detection engine 114 and/or the reversal detection engine 130. Moreover, overlapping divergences and reversals are plotted on the graphical display of the price chart. The processing operations, including the detection of overlaps provide for multiple overlaps, including plotting the overlaps, the line plotting the overlaps get progressively darker where this overlap, in one embodiment.

FIG. 4 illustrates the steps of one embodiment of a method for the detection of divergence within a financial data set and a graphical representation thereof. In this embodiment, step 140 is receiving a plurality of financial data points from the financial data set providing values of the financial data points over a first time interval. As noted above in FIG. 1, the financial data 112 may be from one or more sources providing such information. The first time interval may be designated by a user or may be predetermined by one or more factors, e.g. limited by the amount of data available from the source, or limited by an update or relay factor from the financial data source.

In this embodiment, step 142 is the electronic generation of a graphical display of the financial data points over the first time interval. This graphical display may be generated and provided to the user 102 via the network 106 for display on the device 104 of FIG. 1. The display may be a graphical display that includes time on the x-axis and value points on the y-axis, such as visible in sample screenshots described below.

Referring back to FIG. 3, step 144 is receiving a user selection of a plurality of technical indicators applicable to the financial data points. In the exemplary system 100 of FIG. 1, the user 102 selects, via the computing device 104, one or more technical indicators to be applied to the financial data 112. By way of example, and not limiting in nature, the user may select a first technical indicator of a relative strength index (RSI) and a second indicator of a moving average convergence/divergence (MACD). In one embodiment, the user selection may be via a pull down menu of available technical indicators, or may be in another embodiment the user selection of a radio button or other type of interface for user selection. In reference to FIG. 2, this step may include the activation of the selected engines 114.

Referring back to FIG. 3, step 146 is the applying the financial indicators to the financial data points to generate financial indicator data points. The technical indicator engine 114 of FIG. 1 executing the technical indicator routines on the financial data 112 may accomplish this step.

With reference to FIG. 2, each of the indicator engines 114 may perform specific operational routines on the financial data to generate the technical indicator data.

FIG. 2 illustrates the period/selection filter 120 disposed between the financial data source 112 and the engines 116, but it is recognized that this filter 120 may be disposed at any location within the processing system. The filter 120 provides for a defined time period, such as a first time period, over which the financial data and the technical indicator data points are to be compared. This time period may be user-defined or can be system-defined based on a default setting, with the user adjustment as necessary using any suitable user input and adjustment technique.

Referring back to FIG. 4, step 148 is electronically detecting at least one divergence between the values of the financial data set and the financial data indicator points during a second time interval. In reference to FIG. 2, the divergence detection engine 116 performs the divergence detection operations. The operations may be performed in response to executable instructions, including instructions for comparing the price action, e.g. movement of the equity, versus the movement of the technical indicator data. Based on these movements, the engine 116 therein detects divergences.

In additional embodiments, as described further detail below, the engine 116 additionally performs processing operations or routines using the supplement divergence data engine.

In the embodiment of FIG. 4, the second time interval indicates the time intervals during which the divergences occur, where the second time interval is within the first time interval. For example, if the first time interval is a period of 2 months, the second time interval may be 2 months in duration, but can also be shorter, thus occurring within the first time interval. Thus, as used herein, the first time interval represents the time period covering the scope of financial data and technical indicator data that is analyzed by the engine 116 and the second time interval represents the time period during which divergences occur.

With reference back to FIG. 4, step 149 is to update the graphical display to include a graphical display of the divergences concurrent with the financial data points. In FIG. 1, the processing device 108 may transmit the display information to the user device 104 via the network 106. In FIG. 2, the engine 116 provides the graphical display information, including the financial data, the technical indicator data, and the divergence data from the detection engine 116, to the graphical updating engine 126. The engine 126 is operative therefore to generate the graphical display.

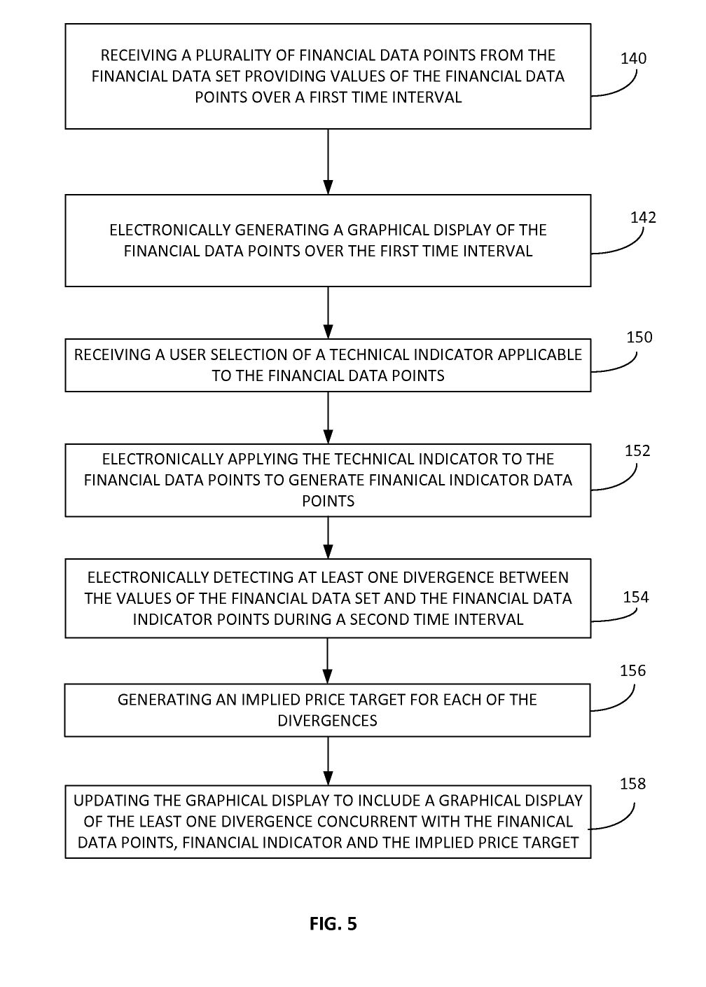

FIG. 5 illustrates a flowchart of another embodiment of a computerized method for the detection of divergence within a financial data set and the graphical representation thereof. The method includes steps 140 and 142 as described above. A next step, step 150, is receiving user selection of a technical indicator application to the financial data points, similar to step 144 above. Whereas, step 144 includes the selection of a plurality of technical indicators, step 150 provides for a single technical indicator. The technical indicator selection may be performed similar to the step 144 above, and in embodiments having multiple technical indicators, the method may repeat step 150 as necessary.

Step 152 is electronically applying the technical indicator to the financial data points to generate technical indicator data points. Step 152 may be identical to step 146 above, include performed by the system 100 of FIG. 1 and the engine(s) 114 of FIG. 1 and FIG. 2.

Step 154 is electronically detecting at least one divergence between the values of the financial data set and the financial data indicator points during a second time interval. Step 154 may be identical to step 148 above, including operations performed by the system 100 FIG. 1 and the engine 116 of FIG. 1 and FIG. 2.

Step 156 is generating an implied price target for each of the divergences. With reference to FIG. 3, the price target indicator engine 132 of the supplemental divergence data engine 122 is operative to provide executable operations for generating this price target, consistent with the price target calculation techniques described above.

The engine 116 thus using the financial data and the technical indicator data and the price target indicator engine, is operative to generate the price target indicator. As noted in FIG. 3, another embodiment includes the application of a color coding via the color coding engine 138 to the price target information generated by the engine 136. This color coding may be user-selected or can be default settings by the engines 116, 130 and/or 134.

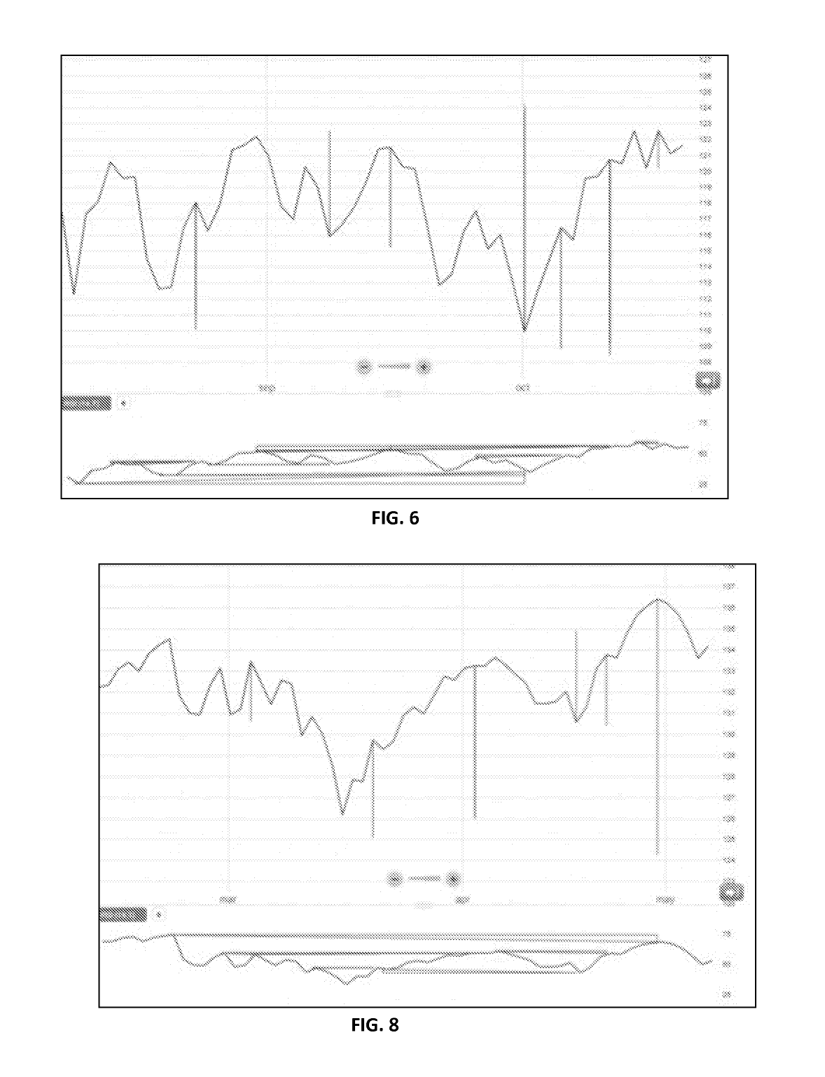

Thereupon, in the method of FIG. 5, step 158 is the updating the graphical display to include a graphical display of at least one divergence concurrent with the financial data points, financial indicator and the implied price target. For further illustration, FIG. 6 includes a sample screenshot of a graphical display including the price target estimation from the engine 132 of FIG. 3. In the screen shot, the upwardly extending lines from the graph represent price targets.

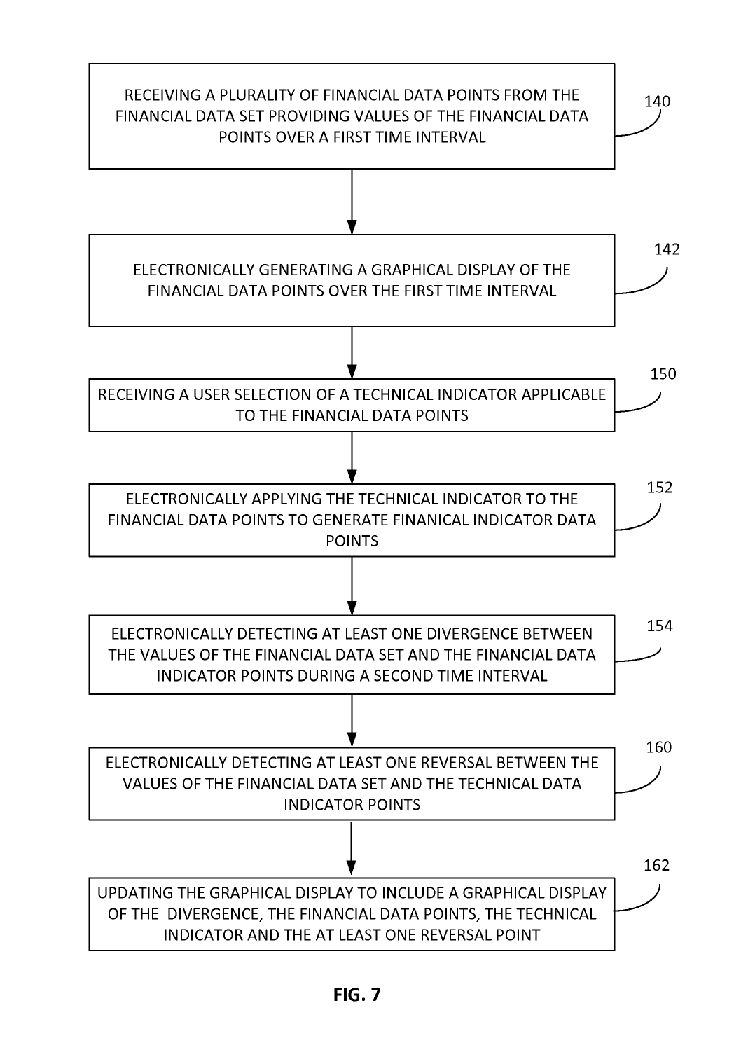

FIG. 7 illustrates another embodiment of a computerized method for the detection of divergence within a financial data set and a graphical representation thereof. The methodology of FIG. 7 is executable on the system 100 of FIGS. 1 and 2, including steps 140, 142, 150, 152 and 154 described above.

Step 160 includes the step of electronically detecting at least one reversal between the values of the financial data set and the technical data indicator points. With reference to FIG. 3, the reversal detection engine 130 is operative to provide such processing functionality on the financial data and technical indicator data.

As noted above, the reversal detection engine 130 operates on the comparison of the financial data and the technical indicator data where a reversal is the opposite of a divergence. Therefore, the engine 130 performs the reversal detection operations similar to the divergence detection.

In further embodiments, the color coding engine 136 may apply color coding to the detected reversal operations. Additionally, the time period selection 120 may adjust or otherwise modify the first time period of the financial data and technical data, and the second time period including the reversal(s) and divergence(s).

With reference back to FIG. 7, step 162 is the updating the graphical display to include a graphical display of the divergence, the financial data points, the technical indicator data and the at least one reversal point. The updating operation may be performed via the update engine 126 of FIG. 2. For further illustration, FIG. 8 includes a sample screenshot of a display including a reversal detected using the reversal detection engine. Moreover, as visible in the screen shot, the upwardly extending line indicates a price target within a reversal.

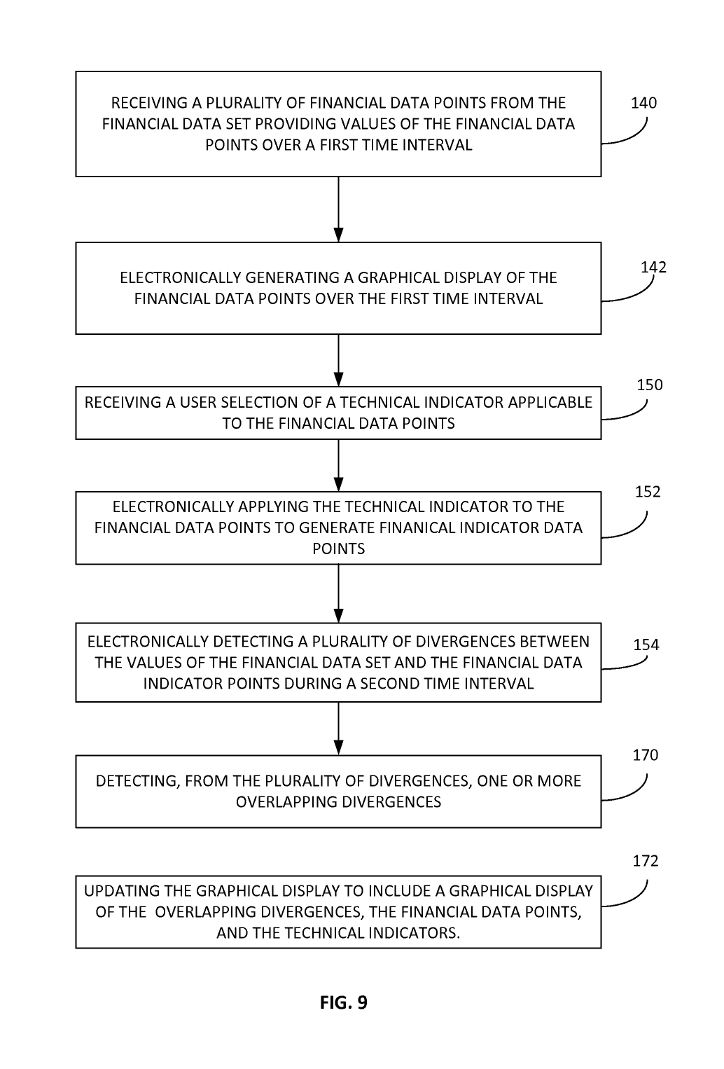

FIG. 9 illustrates another embodiment of a computerized method for the detection of divergence within a financial data set and a graphical representation thereof. The methodology of FIG. 9 is executable on the system 100 of FIGS. 1 and 2, including steps 140, 142, 150, 152 and 154 described above.

Step 170 includes the step of detecting, from the plurality of divergences, one or more overlapping divergences. The reversal detection engine 130 and/or the divergence detection engine 116 of FIG. 3 performs the steps of detecting the overlapping divergence. The engine 130 and/or 116 performs similar divergence detection operations as described above, but also includes steps to detect when multiple divergences overlap, consistent with the processing techniques described above.

As with embodiments above, the overlapping divergence may be applied with a color-coding to effectuate improved graphical display. The engines 116 and 130 may also receive changes in the time period selection and adjust or add/delete overlapping divergences as appropriate.

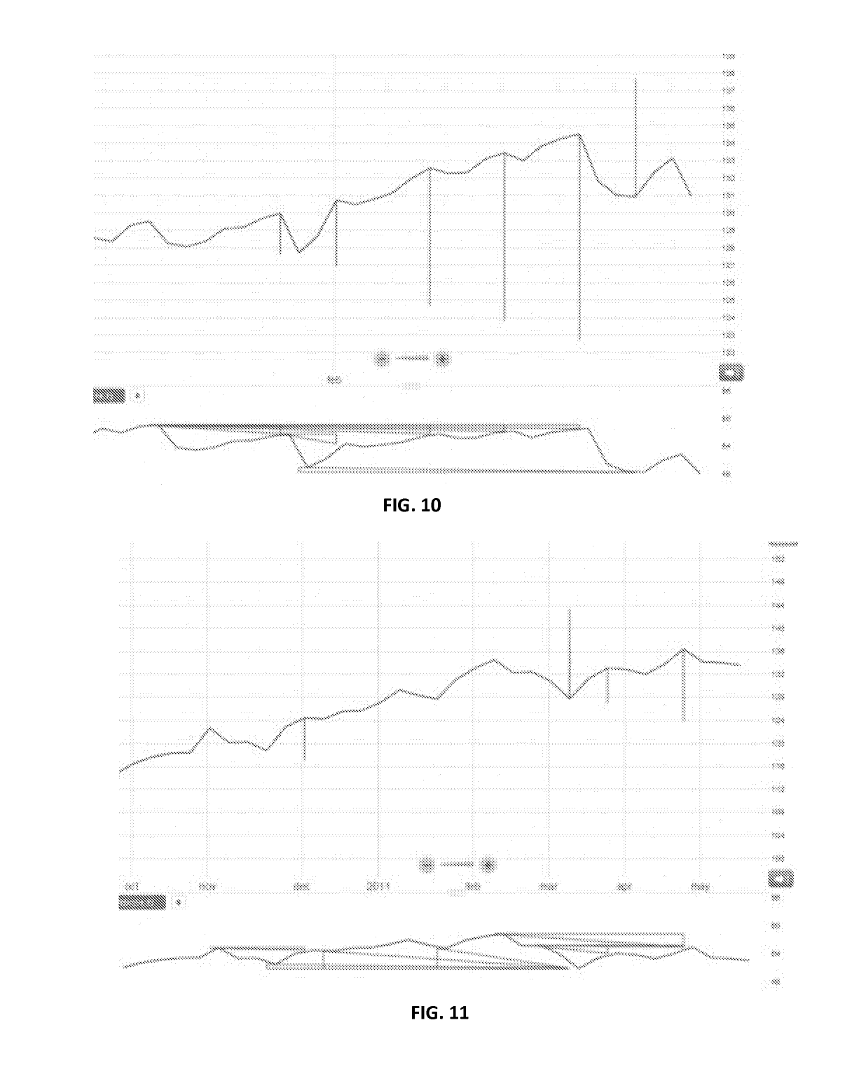

With reference back to FIG. 9, step 172 is the updating the graphical display to include a graphical display of the overlapping divergence, the financial data points, and the technical indicator(s). The updating operation may be performed via the update engine 126 of FIG. 2. For further illustration, FIG. 10 includes a sample screenshot of a display including a reversal detected using the reversal detection engine.

As noted above, and illustrated in FIG. 3, the time period selection 120 allows for the modification of the time period, illustrated in the sample screenshots on the x-axis. FIG. 11 illustrates a sample screen shot of the adjusted graphical display including divergence detection, with the adjustment of the periodicity. Thereupon, the user is able to readily adjust the time period during which the divergence detection occurs, as well as then view the visual display of such plotting of the divergence data.

Therein, using the present method and system, a user is operative to better anticipate or estimate price movements of an equity. The processing and graphical display of the present method and system provides improved divergence detection techniques including utilization of divergence detection for multiple technical indicators, generation of price estimates, detection of overlapping divergences and the reversal detection. Using the above system, the user can select any available equity, as well as technical indicator routine, for divergence detection and graphical display thereof.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for the detection of divergence within a financial data set and a graphical representation thereof, the method comprising:
receiving a plurality of financial data points from the financial data set providing values of the financial data points over a first time interval;
electronically generating a graphical display of the financial data points over the first time interval;
receiving a user selection of a plurality of technical indicators applicable to the financial data points;
electronically applying the technical indicators to the financial data points to generate technical indicator data points;
electronically detecting at least one divergence between the values of the financial data set and the financial data indictor points during a second time interval; and
updating the graphical display to include a graphical display of the least one divergence concurrent with the financial data points and technical indicators.

2. The method of claim 1 wherein the at least one divergence is from a set consisting of: a bearish divergence and a bullish divergence.

3. The method of claim 1 further comprising:
for each of the divergences, generating an implied price target; and
updating the graphical display to include the implied price target.

4. The method of claim 1 further comprising:
electronically detecting at least one reversal between the values of the financial data set and the financial data indicator points; and
updating the graphical display to include the at least one reversal.

5. The method of claim 1 further comprising:
receiving a time period adjustment request from the user via a user input device;
updating the second time period based on the time period adjustment;
electronically detecting any additional divergence between the values of the financial data set and the financial data indictor points during a second time interval; and
updating the graphical display to adjust the display of financial data points, technical indicators and the divergence based on the adjustment request

6. The method of claim 1, wherein the detecting includes detecting a plurality of divergences, the method further comprising:
detecting, from the plurality of divergences, at least one overlapping divergence; and
updating the graphical display to indicate the at least one overlapping divergence.

7. A computerized method for the detection of divergence within a financial data set and a graphical representation thereof, the method comprising:
receiving a plurality of financial data points from the financial data set providing values of the financial data points over a first time interval;
electronically generating a graphical display of the financial data points over the first time interval;
receiving a user selection of a technical indicator applicable to the financial data points;
electronically applying the technical indicator to the financial data points to generate technical indicator data points;
electronically detecting at least one divergence between the values of the financial data set and the financial data indictor points during a second time interval;
for each of the divergences, generating an implied price target; and
updating the graphical display to include a graphical display of the least one divergence concurrent with the financial data points, technical indicator and the implied price target.

8. The method of claim 7 further comprising:
electronically detecting at least one reversal between the values of the financial data set and the financial data indicator points; and
updating the graphical display to include the at least one reversal.

9. The method of claim 7 further comprising:
receiving a time period adjustment request from the user via a user input device;
updating the second time period based on the time period adjustment;
electronically detecting any additional divergence between the values of the financial data set and the financial data indictor points during a second time interval; and
updating the graphical display to adjust the display of financial data points, technical indicator and the divergence based on the adjustment request

10. The method of claim 7, wherein the detecting includes detecting a plurality of divergences, the method further comprising:
detecting, from the plurality of divergences, at least one overlapping divergence; and
updating the graphical display to indicate the at least one overlapping divergence.

11. A computerized method for the detection of divergence within a financial data set and a graphical representation thereof, the method comprising:
receiving a plurality of financial data points from the financial data set providing values of the financial data points over a first time interval;
electronically generating a graphical display of the financial data points over the first time interval;
receiving a user selection of a technical indicator applicable to the financial data points;
electronically applying the technical indicator to the financial data points to generate technical indicator data points;
electronically detecting at least one divergence between the values of the financial data set and the financial data indictor points during a second time interval;
electronically detecting at least one reversal between the values of the financial data set and the financial data indicator points; and
updating the graphical display to include a graphical display of the least one divergence concurrent with the financial data points, the technical indicator and the at least one reversal point.

12. The method of claim 11 further comprising:
for each of the divergences, generating an implied price target; and
updating the graphical display to include the implied price target.

13. The method of claim 11 further comprising:
receiving a time period adjustment request from the user via a user input device;
updating the second time period based on the time period adjustment;
electronically detecting any additional divergence between the values of the financial data set and the financial data indictor points during a second time interval; and
updating the graphical display to adjust the display of financial data points, technical indicators and the divergence based on the adjustment request

14. The method of claim 11, wherein the detecting includes detecting a plurality of divergences, the method further comprising:
detecting, from the plurality of divergences, at least one overlapping divergence; and
updating the graphical display to indicate the at least one overlapping divergence.

15. A system for the detection of divergence within a financial data set and a graphical representation thereof, the system comprising:
a computer readable medium having executable instructions thereon; and
a computer processing device, in response to the executable instructions, operative to:
receive a plurality of financial data points from the financial data set providing values of the financial data points over a first time interval;
electronically generate a graphical display of the financial data points over the first time interval;
receive a user selection of a plurality of technical indicators applicable to the financial data points;
electronically apply the technical indicators to the financial data points to generate technical indicator data points;
electronically detect at least one divergence between the values of the financial data set and the financial data indictor points during a second time interval; and
update the graphical display to include a graphical display of the least one divergence concurrent with the financial data points and technical indicators.

16. The system of claim 15 wherein the at least one divergence is from a set consisting of: a bearish divergence and a bullish divergence.

17. The system of claim 15, the processing device, in response to further executable instructions, further operative to:
for each of the divergences, generate an implied price target; and
update the graphical display to include the implied price target.

18. The system of claim 15, the processing device, in response to further executable instructions, further operative to:
electronically detect at least one reversal between the values of the financial data set and the financial data indicator points; and
update the graphical display to include the at least one reversal.

19. The system of claim 15, the processing device, in response to further executable instructions, further operative to:
receive a time period adjustment request from the user via a user input device;
update the second time period based on the time period adjustment;
electronically detect any additional divergence between the values of the financial data set and the financial data indictor points during a second time interval; and
update the graphical display to adjust the display of financial data points, technical indicators and the divergence based on the adjustment request

20. The system of claim 15, wherein the processing device, when operative to detect includes detecting a plurality of divergences, the processing device, in response to further executable instructions, further operative to
detect, from the plurality of divergences, at least one overlapping divergence; and
update the graphical display to indicate the at least one overlapping divergence.
